(19) United States
(12) Patent Application Publication
(10) Pub. No.: US 2025/0128149 A1
(43) Pub. Date: Apr. 24, 2025

(54) BALANCE CONTROL DEVICE AND SYSTEM

(71) Applicants: HONGFUJIN PRECISION ELECTRONS(YANTAI) CO., LTD., Yantai (CN); HON HAI PRECISION INDUSTRY CO., LTD., New Taipei (TW)

(72) Inventors: CHIEN-HENG CHEN, New Taipei (TW); YU-HSIANG HAO, New Taipei (TW); YAO-CHE PENG, New Taipei (TW)

(21) Appl. No.: 18/809,617

(22) Filed: Aug. 20, 2024

(30) Foreign Application Priority Data
Oct. 18, 2023 (CN) 202311353447.2

(51) Int. Cl. A63F 13/211; A63F 13/218; A63F 13/245

(52) U.S. Cl. CPC A63F 13/211; A63F 13/218; A63F 13/245

(57) ABSTRACT

A balance control device and system are provided. The balance control device includes a balance carrier, a force detector, a control device, and an posture detector. The balance carrier carries a user and presents a corresponding posture according to a force exerted on the balance carrier. The force detector is position in the balance carrier to detect the force to obtain a first sensing data. The posture detector is positioned in the control device and is configured to detect an posture of the control device to obtain a second sensing data. The control device obtains a first result according to the first sensing data and the second sensing data, and transmits the first result to a controlled device for controlling the controlled device to carry out a corresponding processing according to the first result.

### CROSS-REFERENCE TO RELATED APPLICATIONS

This application claims priority to Chinese Patent Application No. 202311353447.2 filed on Oct. 18, 2023, in China National Intellectual Property Administration, the contents of which are incorporated by reference herein.

### FIELD

The subject matter herein generally relates to control technologies, and specially relates to a balance control device and a balance control system.

### BACKGROUND

A human-computer interaction mode generally provides an interactive interface, keys, or hand joysticks to interact. For example, a gaming device provides a hand joystick for the user playing game, which cannot provide more experience.

Therefore, there is room for improvement within the art.

### BRIEF DESCRIPTION OF THE DRAWINGS

Implementations of the present disclosure will now be described, by way of example only, with reference to the attached figures.

FIG. 1 is a schematic diagram illustrating a balance control system according to an embodiment of the present disclosure.

FIG. 2 is a schematic diagram illustrating a balance carrier according to an embodiment of the present disclosure.

FIG. 3 is a schematic diagram illustrating a control device according to an embodiment of the present disclosure.

FIG. 4 is a schematic diagram illustrating a balance control device according to an embodiment of the present disclosure.

FIG. 5 is a schematic diagram illustrating a balance control device according to another

embodiment of the present disclosure.

FIG. 6 is a schematic diagram illustrating a force detector according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better show details and features of the present disclosure.

Several definitions that apply throughout this disclosure will now be presented.

The term “coupled” is defined as connected, whether directly or indirectly through intervening components, and is not necessarily limited to physical connections. The connection may be such that the objects are permanently connected or releasably connected. The term “comprising,” when utilized, means “including, but not necessarily limited to”; it specifically indicates open-ended inclusion or membership in the so-described combination, group, series, and the like.

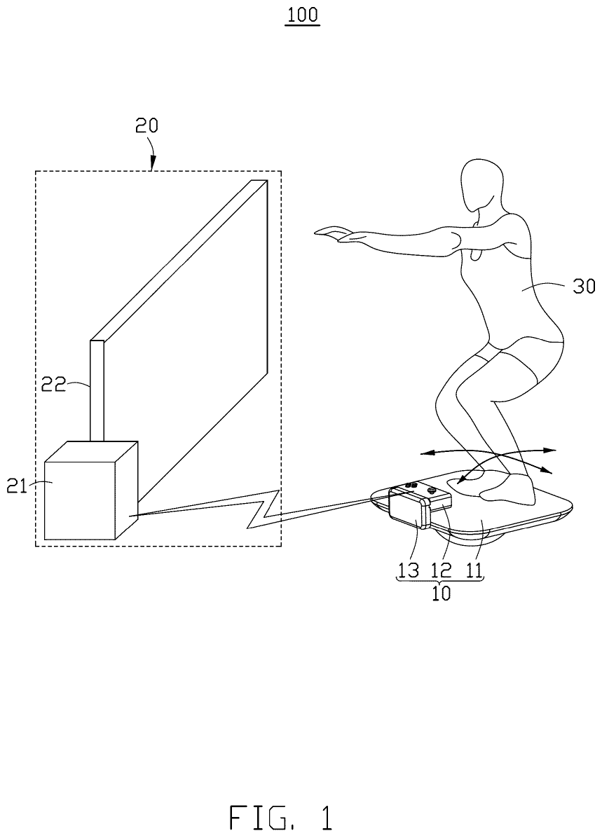

As shown in FIG. 1, a balance control system 100 is provided. The balance control system 100 includes a balance control device 10 and a controlled device 20. The balance control device 10 communicates with the controlled device 20. A communication mode between the balance control device 10 and the controlled device 20 can be wired or wireless communication.

The balance control device 10 is used to receive an operation from a user 30 on the balance control device 10, obtain a first result according to an information related to the received operation, and transmit the first result to the controlled device 20. The controlled device 20 can carry out a corresponding processing according to the first result. In this way, the user 30 can control the controlled device 20 through the balance control device 10.

The balance control device 10 includes a balance carrier 11 and a control device 12.

The balance carrier 11 is used to carry the user 30 and present a corresponding posture according to a force exerted by the user 30. Specifically, when the balance carrier 11 carries the user 30, corresponding to the force exerted by the user 30 on the balance carrier 11, the balance carrier 11 can present a corresponding posture, such as a static posture, a moving posture, an upright posture, and an inclined posture.

In some embodiments, the balance carrier 11 can be a balance plate, or any device capable of presenting corresponding posture depending on the force exerted by the user 30, which is not limited.

In this embodiment, the control device 12 is removably mounted on the balance carrier 11. When the control device 12 is installed on the balance carrier 11, the control device 12 is stationary relative to the balance carrier 11. In other words, when the control device 12 is installed on the balance carrier 11, the control device 12 and the balance carrier 11 can be regarded as a single unit, and the control device 12 does not move spatially relative to the balance carrier 11. For example, when the control device 12 is installed on the balance carrier 11 and the balance carrier 11 tilts 30 degrees to the left, then the control device 12 also tilts 30 degrees to the left with the balance carrier 11.

In this embodiment, the control device 12 is used to obtain a relevant information about the operation exerted by the user 30 on the balance control device 10. The operations exerted by the user 30 on the balance control device 10 include, but is not limited to, operations from the user 30 on the balance carrier 11 and/or operations from the user 30 on the control device 12. The operations from the user 30 on the balance carrier 11 include, but is not limited to, the user 30 standing on the balance carrier 11, the user 30 standing on the balance carrier 11 and controlling the balance carrier 11 to tilt in a certain direction (such as left), and the user 30 performing corresponding actions on the balance carrier 11. In this embodiment, the actions can be squatting or jumping on the balance carrier 11. The operations from the user 30 on the control device 12 include, but is not limited to, operating keys and/or an operation interface of the control device 12.

In this embodiment, the relevant information about the operation obtained by the control device 12 includes, but is not limited to, a first information about the force that the user 30 exerts on the balance carrier 11 and a second information when the control device 12 is operated by the user 30. The first information includes, but is not limited to, a magnitude and/or a direction of the force exerted by the user 30 on the balance carrier 11 and a position of the force exerted on the balance carrier 11. The second information includes, but is not limited to, confirmation information, and/or cancellation information.

In some embodiments, the control device 12 is also used to obtain the first result based on the relevant information and transmit the first result to the controlled device 20. The first result is used to reflect the operation of the user 30 on the balance control device 10. The controlled device 20 can carry out a corresponding processing according to the first result, so that the controlled device 20 carries out corresponding processing according to the operation of the user 30 on the balance control device 10.

In some embodiments, the control device 12 can be a remote control cooperative with the controlled device 20.

In this embodiment, the balance control device 10 can also include a connection structure 13. The connection structure 13 is used to install the control device 12 to the balance carrier 11 for realizing the control device 12 being stationary relative to the balance carrier 11. The connection structure 13 can be detachably installed on the balance carrier 11 or fixed on the balance carrier 11. An exemplary structure of the connection structure 13 will be described later.

The controlled device 20 includes a host 21 and a display 22. The host 21 is used to receive the first result from the balance control device 10. The host 21 performs relevant processing based on the first result. The display 22 is used to display a corresponding interface based on the processing of the host 21.

Specifically, the host 21 generates a control information based on the first result, and the display 22 displays a corresponding picture according to the control information.

In some embodiments, the host 21 and the display 22 can be integrated, such as a laptop computer. In other embodiments, the host 21 and the display 22 can be two separate equipment or devices, for example, the host 21 is a game console and the display 22 is another peripheral device connected to the game console.

The following examples describe some application scenarios of the balance control system 100.

### Application Scenario 1

In this embodiment, the Application Scenario 1 is a fitness scenario. In the fitness scenario, the user 30 stands on the balance carrier 11 with both feet, and a force exerted by a left foot of the user 30 on the balance carrier 11 is greater than a force exerted by a right foot of the user 30 on the balance carrier 11. Then the balance carrier 11 tilts to the left at a first angle. The control device 12 obtains the relevant information of the operation performed by the user 30 on the balance carrier 11 and transmits the first result obtained from the processing of the relevant information to the host 21. The host 21 receives the first result, controls the display 22 to show a first view. In this embodiment, the first view is used to present that both the user 30 and the balance carrier 11 are tilted to the left, and an angle of the balance carrier 11 is the first angle.

### Application Scenario 2

In this embodiment, the Application Scenario 2 is a game scene. In the game scene, the user 30 stands on the balance carrier 11 with both feet, a force exerted by a right foot of the user 30 on the balance carrier 11 is increased, and the balance carrier 11 tilts to the right. The control device 12 obtains the relevant information of the operation performed by the user 30 on the balance carrier 11 and transmits the first result obtained from the processing of the relevant information to the host 21. The host 21 receives the first result and controls a game character moving to the right.

It can be understood that the above application scenarios of the balance control system 100 are only examples, and can also be applied to other scenarios, and this application is not limited.

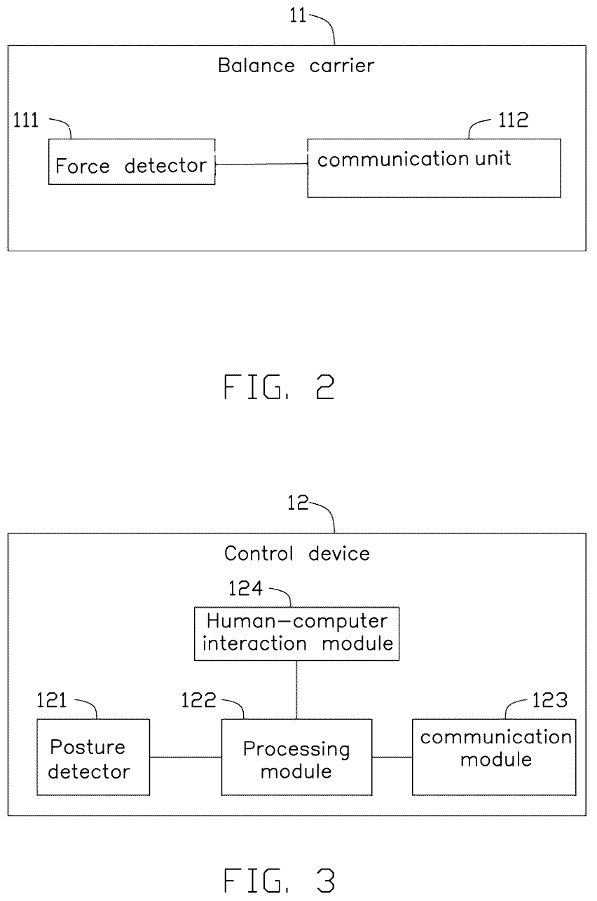

FIG. 2 illustrates a structure of the balance carrier 11. The balance carrier 11 includes a force detector 111 and a communication unit 112.

The force detector 111 is used to detect the force exerted by the user 30 to the balance carrier 11 to obtain a first sensing data. The force detector 111 can be a pressure sensor. The pressure sensor includes, but not limited to, a piezoresistive sensor, a piezoelectric sensor, a capacitive sensor, and a magnetoelectric sensor.

The communication unit 112 communicates with the force detector 111. In this embodiment, the communication between the force detector 111 and the communication unit 112 can be wired communication. The communication unit 112 can be used to implement wired and/or wireless communication with the control device 12. The communication unit 112 is used to receive the first sensing data from the force detector 111 and transmit the first sensing data to the control device 12.

As shown in FIG. 3, the control device 12 includes an posture detector 121, a processing module 122, a communication module 123, and a human-computer interaction module 124. The processing module 122 is connected to the posture detector 121, the communication module 123, and the human-computer interaction module 124.

The posture detector 121 is used to detect an posture of the control device 12 to obtain a second sensing data. When the control device 12 is mounted on the balance carrier 11 to be stationary relative to the balance carrier 11, the posture of the control device 12 is the posture of the balance carrier 11. For example, when the control device 12 is fixed to the balance carrier 11 and the balance carrier 11 tilts to the left, the control device 12 will tilt to the left. That is, when the posture detector 121 detects that the control device 12 tilts to the left, which will indicate that the balance carrier 11 tilts to the left.

The posture detector 121 includes a gyroscope sensor. The gyroscope sensor can be used to determine a motion state of the control device 12. In some embodiments, an angular velocity of the control device 12 around three axes (for example, the x, y, and z axes) can be determined by the gyroscope sensor.

In some embodiments, the posture detector 121 also includes an acceleration sensor. The acceleration sensor detects a magnitude of the acceleration of the control device 12 in all directions (for example, the x, y, and z axes).

In some embodiments, the posture detector 121 also includes a magnetic sensor.

In some embodiments, the posture detector 121 can be further divided into a first sensor and a second sensor. The first sensor is a hardware sensor and is implemented through physical components. The first sensor usually obtains data through measuring specific environmental properties, such as gravitational acceleration or azimuth angle changes. The second sensor is a software sensor and do not rely on physical devices. The second sensor imitates the first sensor and obtain data through one or more first sensors or through invoking virtual sensors or artificial sensors. For example, the second sensor can include a linear acceleration sensor and a gravity sensor.

In this embodiment, the posture of the control device 12 can be determined by a geomagnetic field sensor and an orientation sensor. In detail, the geomagnetic field sensor is the first sensor. The orientation sensor is the second sensor and obtain data through the acceleration sensor and the magnetic sensor.

The communication module 123 is used to establish a communication connection with the communication unit 112 of the balance carrier 11 to obtain the first sensing data detected by the force detector 111.

In this embodiment, the communication connection between the communication module 123 and the communication unit 112 can be wired and/or wireless. The communication module 123 can be a first wired communication module and/or a first wireless communication module. The communication unit 112 can be a second wired communication module and/or a second wireless communication module. The first wired communication module establishes a wired connection with the second wired communication module. The first wireless communication module establishes a wireless connection with the second wireless communication module.

The communication module 123 is also used to transmit the first result or the relevant information of the operation performed by the user 30 on the balance control device 10 to the controlled device 20. The communication module 123 can establish a wired and/or wireless connection with the controlled device 20.

In this embodiment, the processing module 122 is used to obtain the first sensing data and the second sensing data to obtain the first result based on the first sensing data and the second sensing data.

In a first situation, the processing module 122 can obtain the first result based on the first sensing data and the second sensing data, through the following steps 11-14.

Step 11, the processing module 122 determines a corresponding first state sequence based on the first sensing data.

In step 11, the force detector 111 collects the force exerted by the user 30 on the balance carrier 11 in real time to obtain the first sensing data. The first sensing data may include a sensing value.

In step 11, the first state sequence includes one or more sensing values acquired during a sampling period. For example, the sensing values may be a pressure value. A time unit of the sampling period can be minutes or hours.

In this embodiment, taking the sensing value being the pressure value as an example, the first state sequence is N pressure values collected at N sampling moments during the sampling period, and N is a positive integer.

For example, at time T1, the user 30 performs a squat on the balance carrier 11. At time T20, the user 30 completes the squat. The force detector 111 collects the first sensing data from time T1 to time T20, and the processing module 122 obtains 20 pressure values based on the first sensing data. Then, the 20 pressure values forms the first state sequence.

Step 12, the processing module 122 matches the first state sequence with a first reference sequence in an action library, and the first reference sequence with a greatest similarity is taken as a first target reference sequence.

In this embodiment, the action library includes the reference action and the first reference sequence corresponding to the reference action.

In this embodiment, one or more users can be prearranged to perform corresponding reference actions on the balance carrier 11, such as tilting, standing still, and squatting. Then, during a time period when the user does the reference action, the sensor data collected by the force detector 111 is obtained, and the reference sequence corresponding to the reference action is determined according to the sensor data obtained. Thus, the first reference sequence corresponding to the reference action can be obtained.

For example, the action library can store a squatting action and the first reference sequence corresponding to the squatting action, and/or a tilting action and the first reference sequence corresponding to the tilting action.

As descried above, the first state sequence includes the 20 pressure values. The 20 pressure values are compared with the first reference sequence of the action library. When the 20 pressure values and the first reference sequence corresponding to the squatting action are highly matched, the first reference sequence corresponding to the squatting action will be taken as the first target reference sequence.

In some embodiments, due to different locations of the force detector 111 or different body weights of the user 30, the first state sequence and the first reference sequence corresponding to a same action may have a difference. Then, the sensing values, the first state sequence, and the first reference sequence acquired by the force detector 111 may be appropriately adjusted according to a location of the force detector 111 and a body weight of the user 30.

Step 13, the processing module 122 takes the reference action corresponding to the first target reference sequence as the action of the user 30.

As descried above, the processing module 122 takes the first reference sequence corresponding to the squatting action as the first target reference sequence and takes the squatting action as the action of the user 30. That is, the squatting action of the user 30 on the balance carrier 11 is detected.

Step 14, the processing module 122 obtains the first result based on the action of the user 30 and the second sensing data.

In this embodiment, the first result includes the action of the user 30 and the first sensing data. The first sensing data can be an original sensor data collected by the force detector 111 or the data obtained through pre-processing (such as filtering) the original sensor data.

In a second situation, the processing module 122 can obtain the first result based on the first sensing data and the second sensing data, through the following steps 21-25.

Step 21, the processing module 122 determines a first state sequence based on the first sensing data and a second state sequence based on the second sensing data.

In this embodiment, the second state sequence includes one or more sensing values acquired during the sampling period. For example, the sensing values can be various values, such as, accelerometer values, gyroscope values, and magnetic force values. The time unit of the sampling period can be minutes or hours.

Taking the sensing value being the gyroscope value and the accelerometer value as an example, the second state sequence includes N gyroscope values collected at N sampling moments and M accelerometer values collected at M sampling moments during the sampling period. M is a positive integer, and N and M can be the same or different.

A principle or a content of the processing module 122 determining the second state sequence based on the second sensing data is similar to a principle or a content of the processing module 122 determining the first state sequence based on the first sensing data, which will not be repeated herein.

In this embodiment, contents of steps 22, 23 and 24 are similar to steps 12, 13, and 14, which will not be repeated here.

Step 25, the processing module 122 obtains the first result based on the actions of the user 30 and the posture of the balance carrier 11.

In this embodiment, the first result includes the result after the processing module 122 processing the first sensing data and the second sensing data. That is, the first result includes the action of the user 30 and the posture of the balance carrier 11.

In a third situation, the processing module 122 takes the first sensing data and the second sensing data as the first result. The first sensing data can be the original sensor data collected by the force detector 111. The second sensing data can be the original sensor data collected by the posture detector 121. That is, the processing module 122 does not process the first sensing data and the second sensing data. The first sensing data and the second sensing data are received and processed by the controlled device 20. A principle of the controlled device 20 processing the first sensing data and the second sensing data is similar to the processing module 122 as described in the first and second situations, which is not repeated here.

In a fourth situation, the processing module 122 preprocesses the first sensing data and the second sensing data, and the first sensing data and the second sensing data after preprocessing are taken as the first result. A principle of the controlled device 20 processing the preprocessed first sensing data and the second sensing data is similar to the processing module 122 as described in the first and second situations, which is not repeated here.

In this embodiment, the processing module 122 may be a Central Processing Unit, a general purpose processor, a programmable logic device, a discrete gate, a transistor logic device, a discrete hardware component, and the like. The processing module 122 runs an operating system, such as a Linux operating system. The programmable logic device can be, but is not limited to, a Digital Signal Processor (DSP) and an Application Specific Integrated Circuit (ASIC).

In some embodiments, the control device 12 may also include a storage. The storage may be an external memory and/or an internal memory.

The human-computer interaction module 124 receives the operation of the user 30 and obtains a second result in response to the operation of the user 30 on the human-computer interaction module 124. The second result can be transmitted by the communication module 123 to the controlled device 20.

In this embodiment, the human-computer interaction module 124 can be, but is not limited to, a physical key, a human-computer interaction interface, or a voice interaction module.

For example, when the human-computer interaction module 124 includes at least one key and the at least one key includes a confirm button, the processing module 122 obtains the second result in response to the user 30 operating the confirm button. The second result is the confirmation of the user 30. The communication module 123 transmits the second result to the controlled device 20.

In another example, when the human-computer interaction module 124 is a human-computer interaction interface and the human-computer interaction interface includes an input box, the processing module 122 obtains the second result in response to the input operation of the user 30 on the input box. The second result is the information input by the user 30. The user 30 enters an posture information, a confirmation information, or a cancellation information of the current balance carrier 11 through the human-computer interaction module 124. For example, in the game scene, the controlled device 20 determines that the balance carrier 11 is tilted to the right based on the first result, when in fact the balance carrier 11 is tilted to the right. Then, the user 30 can enter an posture information of the current balance carrier 11 as leaning to the left through the human-computer interaction module 124 to correct a detection result. Alternatively, the controlled device 20 determines that the balance carrier 11 is tilted to the right based on the first result, and the user 30 can enter a confirmation information through the human-computer interaction module 124 to indicate that the detection result is correct.

As described above, the balance carrier 11 can be a balance plate or any device capable of presenting corresponding posture depending on the force applied by the user 30. The following will take the balancing carrier 11 being the balance plate as an example.

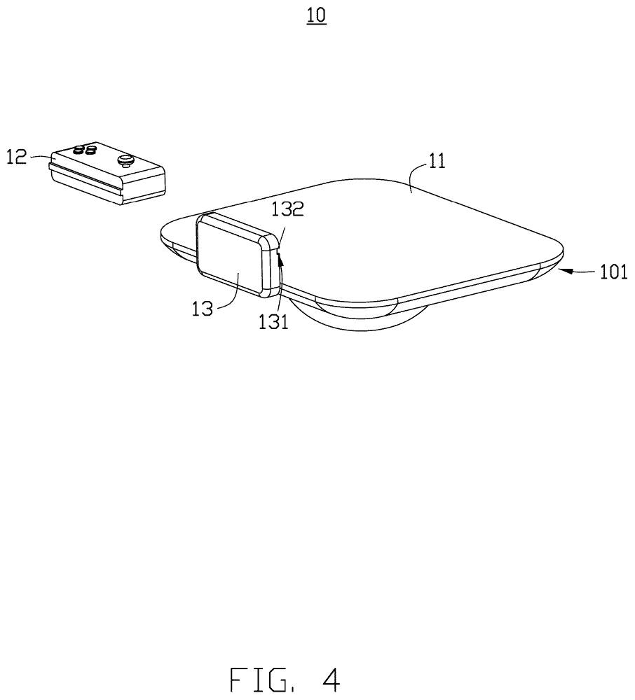

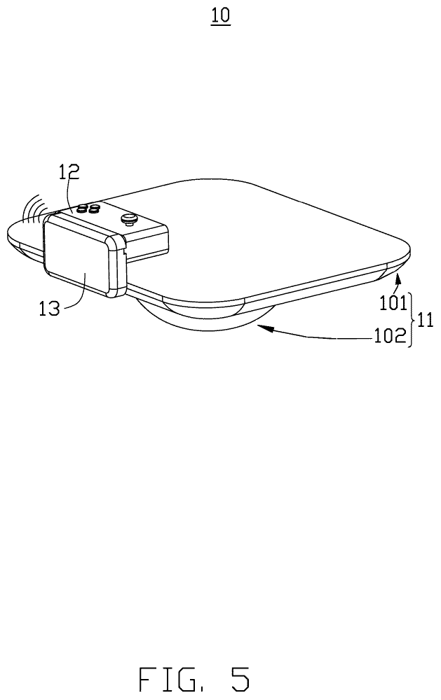

As shown in FIG. 4 and FIG. 5, the balance plate includes a plate 101 and a base 102. An upper surface of the plate 101 is positioned for the user 30 to stand. In some embodiments, the base 102 has a size smaller than a size of the plate 101 and is arranged at a bottom of the plate 101. The base 102 can be spherical or other shapes to facilitate the tilting of the base 102 and/or the plate 101.

Then, when the user 30 exerts the force towards the plate 101, the balance carrier 11 will tilt due to the force exerted by the user 30 for presenting the corresponding posture, such as stationary posture, leaning to the left, leaning to the right, leaning to the back, etc. Accordingly, the balance carrier 11 will tilt at different angles due to the force exerted by the user 30, such as tilt 15 degrees, tilt 30 degrees. Therefore, when the user 30 exerts the force towards the plate 101, the direction and magnitude of the force should be controlled to make the balance carrier 11 keeping balance or tilting in a specific direction.

In some embodiments, a shape and/or a size of the base 102 is not limited, and only to ensure that the base 102 is made of an elastic material to facilitate the tilting of the base 102 and/or the plate 101.

As shown in FIG. 4, the connection structure 13 is positioned at the side of the balance plate. When the connection structure 13 is installed on the balance plate, the connection structure 13 is stationary relative to the balance plate. That is, when the connection structure 13 is arranged on the balance plate and when the balance plate is in various locations, the connection structure 13 will not move in space relative to the balance plate when the balance plate.

The connecting structure 13 defines a fixed slot 131. The fixed slot 131 is used for holding the control device 12. As shown in FIG. 4 and FIG. 5, through inserting the control device 12 into the fixing slot 131, the control device 12 is connected with the connecting structure 13. The connecting structure 13 connecting with the control device 12 is fixed on the balance plate.

As shown in FIG. 4, in some embodiments, the connection structure 13 further includes a fixing member 132. When the control device 12 is accommodated in the fixed slot 131, the fixing member 132 is used to fix the control device 12 to the fixed slot 131 for ensuring that the control device 12 does not move relative to the balance plate when the balance plate is in motion. In some embodiments, the fixing member 132 can be, but is not limited to, a clasp.

As described above, the connection structure 13 is an independent component. In other embodiments, the connection structure 13 can be a portion of the plate 101. For example, a top surface of the plate 101 defines a fixing slot. The fixing slot forms the connection structure 13.

In some embodiments, the communication unit 112 is arranged in the connection structure 13. When the control device 12 is installed on the balance carrier 11 through the connection structure 13, the communication unit 112 establishes a communication connection between the control device 12 and the balance carrier 11.

For example, the communication module 123 includes a first communication interface. The communication unit 112 includes a second communication interface. The second communication interface is arranged in the connection structure 13. When the control device 12 is inserted into the fixed slot 131, the first communication interface of the control device 12 is electrically connected to the second communication interface of the connection structure 13, thereby realizing the communication connection between the communication module 123 and the communication unit 112. Based on the communication connection between the communication module 123 and the communication unit 112, the first sensing data detected by the force detector 111 can be transmitted to the processing module 122 of the control device 12.

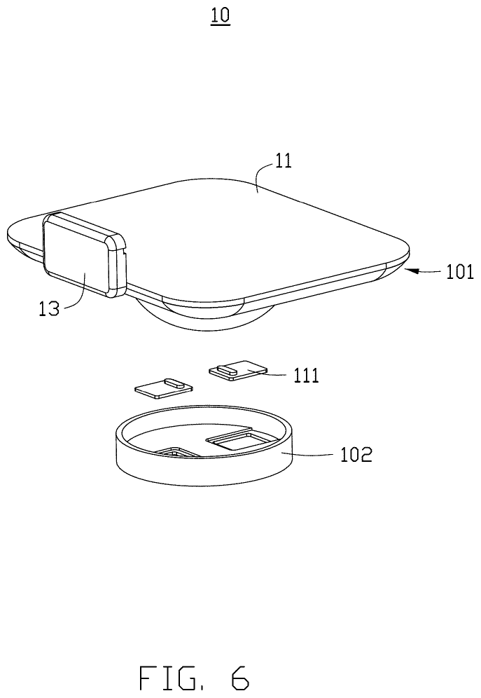

In this embodiment, the force detector 111 is positioned in the balance carrier 11. As shown in FIG. 6, the force detector 111 can be arranged inside the base 102.

In some embodiments, the force detector 111 may be positioned on the plate 101. Taking the force detector 111 being a piezoresistive sensor as an example, the force detector 111 is positioned on the upper surface of the plate 101. The piezoresistive sensor is a sensor made of the piezoresistive effect of monocrystal silicon material and integrated circuit technology, when it is subjected to pressure, a silicon diaphragm pasted on the surface of the sensor produces extremely small strain that is not perceptible to the naked eye. The electronic energy level state inside the atomic structure of the silicon diaphragm changes, resulting in changes in resistivity, which causes great changes in resistance. Through the measurement circuit, the resistance change is converted into a voltage signal output proportional to a force change, and the pressure of the piezoresistive sensor can be measured by measuring the electrical signal.

In this embodiment, through installing the control device 12 on the balance carrier 11, when the posture of the balance carrier 11 changes, the control device 12 will also change the posture along with the posture change of the balance carrier 11. Then the posture detector 121 inside the control device 12 can detect the posture of the balance carrier 11, thereby the relevant information of the force exerted on the balance carrier 11 can be obtained through the posture detector 121. Furthermore, through establishing a communication between the control device 12 and the force detector 111 inside the balance carrier 11, the relevant information of the user exerting a force on the balance carrier 11 can be obtained by the force detector 111. The control device 12 controlling the controlled device 20 based on the information about the force obtained, can provide control methods for the user 30 to improve user experience.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A balance control device, comprising:
a balance carrier, configured to carry a user and present a corresponding posture according to a force exerted on the balance carrier;
a force detector, positioned in the balance carrier and configured for detecting the force to obtain a first sensing data;
a control device, removably mounted on the balance carrier; and
an posture detector, positioned in the control device and configured to detect an posture of the control device to obtain a second sensing data,
wherein the control device is configured to obtain a first result according to the first sensing data and the second sensing data, and transmit the first result to a controlled device for controlling the controlled device to carry out a corresponding processing according to the first result.

2. The balance control device of claim 1, further comprising a connection structure, wherein the connecting structure is configured for mounting the control device on the balance carrier.

3. The balance control device of claim 2, wherein the connection structure is detachably installed on the balance carrier.

4. The balance control device of claim 2, wherein the control device is detachably installed on the connecting structure.

5. The balance control device of claim 2, wherein the balance carrier comprises a communication unit, the control device comprises a communication module;
the communication unit is configured to communicate with the communication module for transmitting the first sensing data to the communication module, the control device is configured to transmit the first result to the controlled device through the communication module.

6. The balance control device of claim 5, wherein the communication unit is arranged in the connection structure.

7. The balance control device of claim 2, wherein the connecting structure defines a fixed slot, the fixed slot is configured to receive the control device.

8. The balance control device of claim 7, wherein the connecting structure further comprises:
a fixing member, the fixing member is arranged in the fixing slot and configured for securing the control device to the fixing slot.

9. The balance control device of claim 1, wherein the control device comprises a processing module, the processing module is configured to:
obtain the first result according to the first sensing data and the second sensing data;
determine a corresponding first state sequence based on the first sensing data;
match the first state sequence with a first reference sequence in an action library;
take the first reference sequence with a greatest similarity as a first target reference sequence;
take a reference action corresponding to the first target reference sequence as an action of the user;
obtain the first result based on the action of the user and the second sensing data.

10. The balance control device of claim 1, wherein the control device comprises a processing module, the processing module is configured to:
obtain the first result according to the first sensing data and the second sensing data;
determine a corresponding first state sequence based on the first sensing data, and determine a corresponding second state sequence based on the second sensing data;
match the first state sequence with a first reference sequence in an action library, and match the second state sequence with a second reference sequence in the action library;
take a first reference sequence with the greatest similarity as a first target reference sequence, and take the second reference sequence with the greatest similarity as a second target reference sequence;
take the reference action corresponding to the first target reference sequence as the action of the user, and take the reference posture corresponding to the second target reference sequence as the posture of the balance carrier;
obtain the first result based on the action of the user and the posture of the balance carrier.

11. The balance control device of claim 1, wherein the control device comprises a human-computer interaction module and a communication module;
the human-computer interaction module is configured to receive an operation of the user and obtain a second result in response to the operation;
the communication module is configured to transmit the second result to the controlled device.

12. The balance control device of claim 5, wherein the communication module comprises a first wireless communication module, the communication unit comprises a second wireless communication module, the second wireless communication module is configured to communicate with the force detector and communicate with the first wireless communication module to transmit the first sensing data to the control device.

13. The balance control device of claim 5, wherein the communication module comprises a first wired communication module, the communication unit comprises a second wired communication module, the second wired communication module is configured to communicate with the force detector and communicate with the first wired communication module to transmit the first sensing data to the control device.

14. A balance control system, comprising:
a controlled device;
a balance control device, configured to communicate with the controlled device; wherein the balance control device comprises:
a balance carrier, configured to carry a user and present a corresponding posture according to a force exerted on the balance carrier;
a force detector, positioned in the balance carrier and configured for detecting the force to obtain a first sensing data;
a control device, removably mounted on the balance carrier;
an posture detector, positioned in the control device and configured to detect an posture of the control device to obtain a second sensing data;
wherein the control device is configured to obtain a first result according to the first sensing data and the second sensing data, and transmit the first result to the controlled device;, the controlled device carries out a corresponding processing according to the first result.

15. The system of claim 14, wherein the controlled device comprises:
a display, configured to present a corresponding interface according to a control information of the controlled device.

16. The system of claim 14, wherein the balance control device further comprises:
a connection structure, wherein the connecting structure is configured for mounting the control device on the balance carrier.

17. The system of claim 16, wherein the connection structure is detachably installed on the balance carrier.

18. The system of claim 16, wherein the control device is detachably installed on the connecting structure.

19. The system of claim 16, wherein the balance carrier comprises a communication unit, the control device comprises a communication module;
the communication unit is configured to communicate with the communication module for transmitting the first sensing data to the communication module, the control device is configured to transmit the first result to the controlled device through the communication module.

20. The system of claim 19, wherein the communication unit is arranged in the connection structure.
